(19) United States
(12) Patent Application Publication
(10) Pub. No.: US 2008/0238883 A1
(43) Pub. Date: Oct. 2, 2008

(54) LIQUID CRYSTAL DEVICE

(76) Inventor: Takashi Akiyama, Sayama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/057,229

(22) Filed: Mar. 27, 2008

(30) Foreign Application Priority Data
Mar. 28, 2007 (JP) 2007-084415
Feb. 22, 2008 (JP) 2008-041946

(51) Int. Cl. G06F 3/044; G02F 1/133

(52) U.S. Cl. 345/174

(57) ABSTRACT

An object of the invention is to provide a liquid crystal device that can produce a display and allow data input thereon with a simple configuration. The liquid crystal device includes a liquid crystal layer provided between first and second substrates, and a capacitive sensor electrode, which is not provided with a counter electrode, and a segment electrode for driving a liquid crystal, both formed on the first or second substrate at a side thereof that faces the liquid crystal layer.

The entire contents of Japanese Patent Application No. 2007-84415 and No. 2008-41946 are hereby incorporated by reference.

### FIELD OF THE INVENTION

The present invention relates to a liquid crystal device, and more specifically to a liquid crystal device having display electrodes and sensor electrodes.

### BACKGROUND OF THE INVENTION

It is known to provide a liquid crystal display device that has display pixel electrodes and data input electrodes (for example, patent document 1). In such a liquid crystal display device, when a data input pen touches a data input electrode, signals are sent from the data input electrode to a coordinate determining circuit, etc., via a signal cable connected to the pen, to determine the coordinates pointed to with the pen.

However, this type of liquid crystal device has had deficiencies for use as a portable liquid crystal display device, because it requires not only a data input pen, but also a signal cable.

On the other hand, it is known to provide a liquid crystal display device incorporating touch sensors which is designed to input data using a finger (for example, patent document 2). In such a liquid crystal display device, a first touch electrode and a second touch electrode are provided on a pair of opposing substrates by sandwiching a liquid crystal layer therebetween, and when a user presses one substrate with a finger, the first and second touch electrodes are brought into contact with each other, thus enabling the position of the press to be determined.

Generally, there are cases where tiny spacer balls are included in the liquid crystal layer in order to keep the thickness of the liquid crystal layer constant. However, there has been a problem that when the liquid crystal layer is deflected under pressure causing the first and second touch electrodes to contact each other, the spacers move around and become unable to function as intended, therefore, the above liquid crystal display device has had to use column-shaped spacers to keep the thickness of the liquid crystal layer constant while allowing a certain amount of deflection of the liquid crystal layer.

Patent document 1: Japanese Patent No. 3358744 (FIG. 2)

Patent document 2: Japanese Unexamined Patent Publication No. 2001-75074 (FIG. 3)

### SUMMARY OF THE INVENTION

Accordingly, it is an object of the present invention to provide a liquid crystal device that can solve the above problems.

It is another object of the invention to provide a liquid crystal device that can produce a display and allow data input thereon with a simple configuration using sensor electrodes.

A liquid crystal device according to the present invention includes a liquid crystal layer provided between first and second substrates, and a capacitive sensor electrode, which is not provided with a counter electrode, and a segment electrode for driving a liquid crystal, both formed on the first or second substrate at a side thereof that faces the liquid crystal layer.

Preferably, in the liquid crystal device according to the present invention, the capacitive sensor electrode is disposed around the segment electrode.

Preferably, in the liquid crystal device according to the present invention, the counter electrode is held in a floating state.

Preferably, in the liquid crystal device according to the present invention, the capacitive sensor electrode and the segment electrode are formed on the first substrate or the second substrate, whichever is located on a viewer side.

Preferably, in the liquid crystal device according to the present invention, the segment electrode and the capacitive sensor electrode are formed in a touch area within the liquid crystal device.

Preferably, in the liquid crystal device according to the present invention, the capacitive sensor electrode is formed larger in area than the segment electrode.

Preferably, the liquid crystal device according to the present invention further includes an erroneous detection prevention wiring line connected to the capacitive sensor electrode.

Preferably, the liquid crystal device according to the present invention comprises a plurality of capacitive sensor electrodes and a plurality of wiring lines connected to the plurality of capacitive sensor electrodes, wherein the plurality of wring lines are arranged one adjacent to another.

Preferably, in the liquid crystal device according to the present invention, the segment electrode is an electrode for passive driving.

Preferably, in the liquid crystal device according to the present invention, the first or second substrate is a flexible substrate.

Preferably, in the liquid crystal device according to the present invention, a voltage for the capacitive sensor electrode is set smaller than a voltage applied to the liquid crystal layer.

According to the present invention, since the sensor electrodes formed from a transparent electrode pattern and capable of functioning without requiring substantially deflecting the liquid crystal layer are used in combination with the display electrodes, it is possible to produce a display and allow data input thereon with a simple configuration.

### BRIEF DESCRIPTION OF THE DRAWINGS

These and other features and advantages of the present invention will be better understood by reading the following detailed description, taken together with the drawings wherein:

FIG. 1 is a cross-sectional view schematically showing a liquid crystal device 10 according to the present invention;

FIG. 2(a) is a diagram showing one example of a first transparent electrode pattern 12, and FIG. 2(b) is a diagram showing one example of a second transparent electrode pattern 15;

FIG. 3 is a diagram showing a capacitance that occurs between a finger and a sensor electrode shown in FIG. 2;

FIG. 4 is a schematic diagram showing the configuration of a detection circuit corresponding to FIGS. 2 and 3;

FIG. 5(a) is a diagram showing one example of a waveform when a user's finger is present, and FIG. 5(b) is a diagram showing one example of a waveform when a user's finger is not present;

FIG. 6(a) is a diagram showing one example of the first transparent electrode pattern 12 which is the same as that shown in FIG. 2(a), and FIG. 6(b) is a diagram showing one example of an alternative first transparent electrode pattern 12′;

FIG. 7(a) is a diagram showing one example of the first transparent electrode pattern 12 which is the same as that shown in FIG. 2(a), and FIG. 7(b) is a diagram showing one example of an alternative second transparent electrode pattern 15′;

FIG. 8(a) is a diagram showing the case where a finger is not present, and FIG. 8(b) is a diagram showing the case where a finger is present;

FIG. 9 is a schematic diagram showing the configuration of a detection circuit corresponding to FIGS. 7 and 8;

FIG. 10(a) is a diagram showing one example of the first transparent electrode pattern 12 which is the same as that shown in FIG. 2(a), and FIG. 10(b) is a diagram showing one example of an alternative second transparent electrode pattern 15″; and

FIG. 11(a) is a diagram showing one example of a first transparent electrode pattern 300, and FIG. 11(b) is a diagram showing one example of a second transparent electrode pattern 400.

### DETAILED DESCRIPTION OF THE PREFERRED EMBODIMENT

A liquid crystal device according to the present invention will be described below with reference to the drawings. However, it should be noted that the technical scope of the present invention is not limited by the specific embodiments described herein, but embraces the inventions described in the appended claims and their equivalents.

FIG. 1 is a cross-sectional view schematically showing the liquid crystal device 10 according to the present invention.

The liquid crystal device 10 comprises a first transparent substrate 11, a second transparent substrate 16, a sealing member 19, a plurality of spacers 18 arranged so as to hold a constant gap between the first and second transparent substrates 11 and 16, and a liquid crystal layer 17 sealed between the first and second transparent substrates 11 and 16 by the sealing member 19. The first transparent substrate 11 is located on the viewer side so that the user views the liquid crystal device 10 from above the first transparent substrate 11 in the figure.

A first transparent electrode pattern 12 and a first alignment film 13 are formed on the first transparent substrate 11, while a second transparent electrode pattern 15 and a second alignment film 15 are formed on the second transparent substrate 16. It should be noted that, for illustrative purposes, the figures given herein may not be drawn to scale.

The liquid crystal layer 17 is formed from a commonly used liquid crystal material such as a TN (Twisted Nematic) liquid crystal.

The first and second transparent substrates 11 and 16 are each formed from a flexible polycarbonate resin with a thickness of 100 μm. However, the first and second transparent substrates 11 and 16 are not limited to this specific material, but use may be made of a modified acrylic resin, a polymethyl methacrylate resin, a polyether sulfone resin, a polyethylene terephthalate resin, a norbornene resin, glass, or the like, and the thickness may be set to a suitable thickness within a range of 50 μm to 250 μm.

The first and second transparent electrode patterns 12 and 15 are each formed by sputtering a transparent conductive film of ITO to a thickness of about 0.03 μm over the first or second transparent substrate 11 or 16, followed by etching to remove unwanted portions. The liquid crystal device 10 is constructed so that the liquid crystal layer 17 is switched from transmissive mode to non-transmissive mode and vice versa by applying a prescribed AC voltage between the first and second transparent electrode patterns 12 and 15.

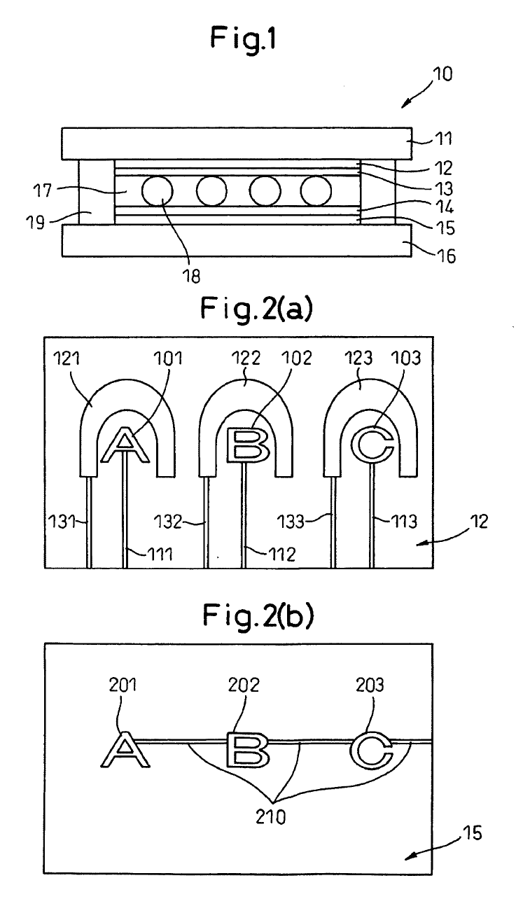

FIG. 2 is a diagram showing one example of the transparent electrode pattern.

FIG. 2(a) shows one example of the first transparent electrode pattern 12. In the example of FIG. 2(a), the first transparent electrode pattern 12 includes a letter “A” shaped first segment electrode 101, a letter “B” shaped second segment electrode 102, a letter “C” shaped third segment electrode 103, a wiring line 111 to the first segment electrode, a wiring line 112 to the second segment electrode, a wiring line 113 to the third segment electrode, a first sensor electrode 121, a second sensor electrode 122, a third sensor electrode 123, a wiring line 131 to the first sensor electrode, a wiring line 132 to the second sensor electrode, and a wiring line 133 to the third sensor electrode.

Segment electrode here means an electrode that has a shape to be displayed, such as a letter, number, character, or a portion thereof.

The first sensor electrode 121 is disposed in close proximity to the first segment electrode 101 so as to surround it, and has a larger area than the first segment electrode. Likewise, the second sensor electrode 122 is disposed in close proximity to the second segment electrode 102 so as to surround it, and has a larger area than the second segment electrode. Similarly, the third sensor electrode 123 is disposed in close proximity to the third segment electrode 103 so as to surround it, and has a larger area than the third segment electrode.

FIG. 2(b) shows one example of the second transparent electrode pattern 15. In the example of FIG. 2(b), the second transparent electrode pattern 15 includes a first counter electrode 201 disposed opposite the first segment electrode 101, a second counter electrode 202 disposed opposite the second segment electrode 102, a third counter electrode 203 disposed opposite the third segment electrode 103, and wiring lines 210 interconnecting the counter electrodes. The first counter electrode 201, second counter electrode 202, and third counter electrode 203 are all held at the same potential and thus function as a common electrode.

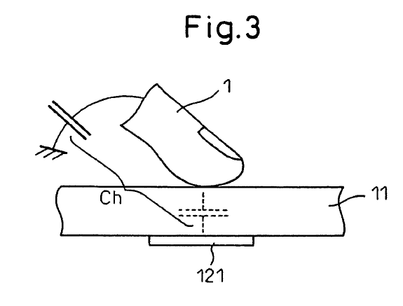

FIG. 3 is a diagram showing a capacitance that occurs when a finger is touched to one of the sensor electrodes shown in FIG. 2.

As shown in FIG. 3, when a user's finger 1 is placed on the first transparent substrate 11 at a position corresponding, for example, to the first sensor electrode 121, capacitance Ch occurs which is the sum of the capacitance occurring between the first sensor electrode 121 and the finger and the capacitance of the human body obtained via the finger. The detection circuit hereinafter described detects this capacitance Ch and determines on which sensor electrode an input has been made.

As shown in FIGS. 2 and 3, the sensor electrodes of the liquid crystal device 10 are included in the first transparent electrode pattern 12 formed on the first transparent substrate 11 disposed on the viewer side. The reason is that since the user's finger touches the liquid crystal display device 100 from the viewer side thereof, the detection sensitivity becomes higher when the sensor electrodes are provided on the first transparent substrate disposed on the viewer side.

Further, as shown in FIGS. 2 and 3, in the liquid crystal device 10, counter electrodes for the sensor electrodes are not formed in the second transparent electrode pattern 15. The reason is that the amount of change of the capacitance Ch occurring between the user's finger 1, which is assumed to be grounded and the sensor electrode can be made larger as explained with reference to FIG. 3, to facilitate the detection. If counter electrodes (connected to ground) for the sensor electrodes are formed in the second transparent electrode pattern 15, since the liquid crystal layer 17 is as thin as about 10 μm, a capacitance whose value does not change appreciably will occur between the sensor electrode and the counter electrode. Compared with this capacitance, the capacitance Ch occurring between the user's finger 1 and the sensor electrode is too small, and its detection sensitivity therefore drops. In this case, if the counter electrode is floats, the capacitance between the sensor electrode and the ground via the counter electrode decreases, and as a result, the capacitance Ch becomes relatively large and easier to detect.

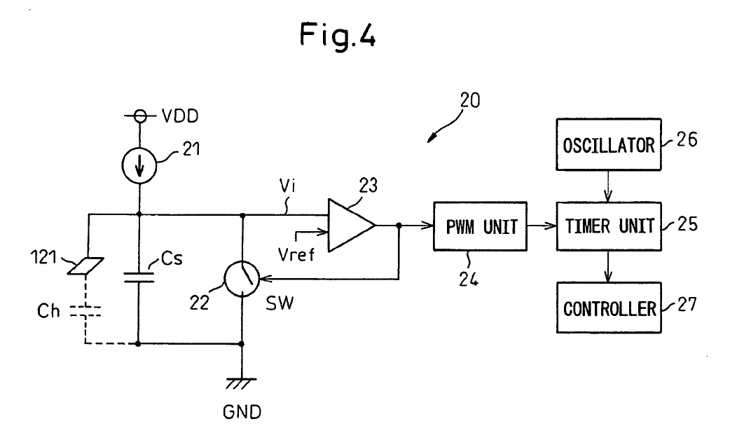

FIG. 4 is a schematic diagram showing the configuration of a detection circuit corresponding to FIGS. 2 and 3.

The detection circuit 20 comprises a supply voltage VDD, the first sensor electrode 121, the capacitance Ch occurring between the first sensor electrode 121 and the finger 1, a fixed capacitance Cs connected in parallel to the capacitance Ch, a constant current source 21, a switch SW 22, a comparator circuit 23, a PWM unit 24, a timer unit 25, an oscillator 26 for the timer unit, and a controller 27 containing a CPU, etc. The detection circuit 20 detects whether or not the user's finger is placed on the first sensor electrode 121 by detecting a change in capacitance using a capacitive coupling method.

When the user's finger is not placed on the first substrate 11 corresponding to the first sensor electrode 121, the constant current source 21 charges only the capacitance Cs, but when the finger is placed on it, the capacitance Ch is added, and the constant current source 21 thus charges the capacitance Cs+Ch.

It is assumed that, in the initial state, the SW 22 is OFF, the terminal voltage of the fixed capacitance Cs is 0 V, and the output of the comparator circuit 23 is low. Then, the fixed capacitance Cs (or Cs+Ch) is charged by the constant current source 21, and the terminal voltage Vi of Cs rises. The terminal voltage Vi is constantly compared with a reference voltage Vref in the comparator circuit 23, and when the terminal voltage Vi exceeds the reference voltage Vref, the output of the comparator circuit 23 goes high. When the output of the comparator circuit 23 goes high, the SW 22 is ON, and the charge stored on the fixed capacitance Cs (or Cs+Ch) is thus released via the SW 22; as a result, the terminal voltage Vi of the fixed capacitance Cs returns to 0 V. The output of the comparator circuit 23 thus returns to the low level. In this way, the output level of the comparator circuit 23 cycles between low and high periodically.

The PWM unit 24 outputs a signal having a pulse width corresponding the length of period that the output of the comparator circuit 23 changes from low to high. The timer unit 25, based on the oscillation pulses from the oscillator 26, counts the number of pulses corresponding to the pulse width of the signal output from the PWM unit 24, and supplies the counting result to the controller 27. The controller 27 determines, based on the counting result, whether the user's finger is placed on the first substrate 11 corresponding to the first sensor electrode 121.

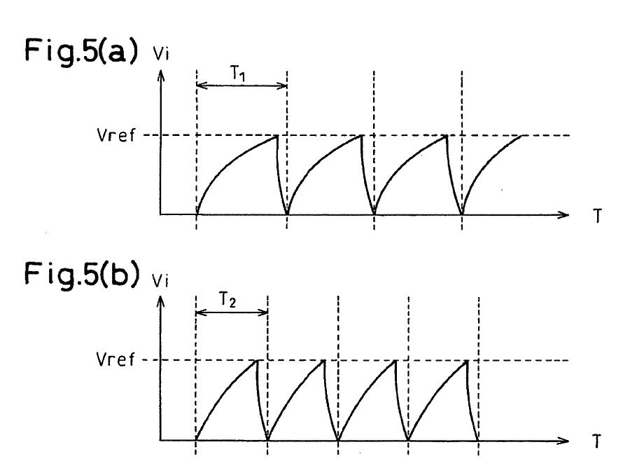

FIG. 5 is a diagram showing one example of the terminal voltage Vi of the fixed capacitance Cs.

FIG. 5(a) shows the case where the total capacitance is Cs+Ch when the user's finger is placed on the substrate, and FIG. 5(b) shows the case where the total capacitance is Cs when the user's finger is not placed on the substrate. In FIGS. 5(a) and 5(b), the ordinate represents the terminal voltage Vi of Cs, and the abscissa represents the time T.

As shown, when the user's finger is placed on the substrate, since the total capacitance is larger, the period T1 during which the output of the comparator circuit 23 changes from low to high becomes longer than the period T2 when the user's finger is not placed on the substrate. Accordingly, the controller 27 can determine, based on the counting result from the timer unit 25, whether the user's finger is placed on the sensor electrode or not, and by setting the reference voltage Vref smaller than the Vth of the liquid crystal 17, the liquid crystal 17 can be prevented from being changed electrically by the charge voltage of the sensor electrode, thus alleviating any adverse effects on the display.

FIG. 4 has shown one example of the detection circuit 20 for detecting whether or not a finger is placed on the first sensor electrode 121, but it is to be understood that actually such a detection circuit is provided for each of the other sensor electrode. It should also be understood that the detection circuit 20 shown in FIG. 4 is only one example and that another circuit configuration may be employed.

As described above, the liquid crystal device 10 displays a segment by applying, for example, a prescribed AC voltage between the desired segment electrode and the common electrode and thereby controlling the transmission/non-transmission state of the liquid crystal layer held between the electrodes (passive driving), and when any portion of the displayed segment is touched with the user's finger, the user input position can be determined using the detection circuit shown in FIG. 4. In this way, by including the display electrodes and sensor electrodes in the liquid crystal display transparent electrode patterns, the liquid crystal device 10 can produce a display and determine the location of an input position with a simple configuration.

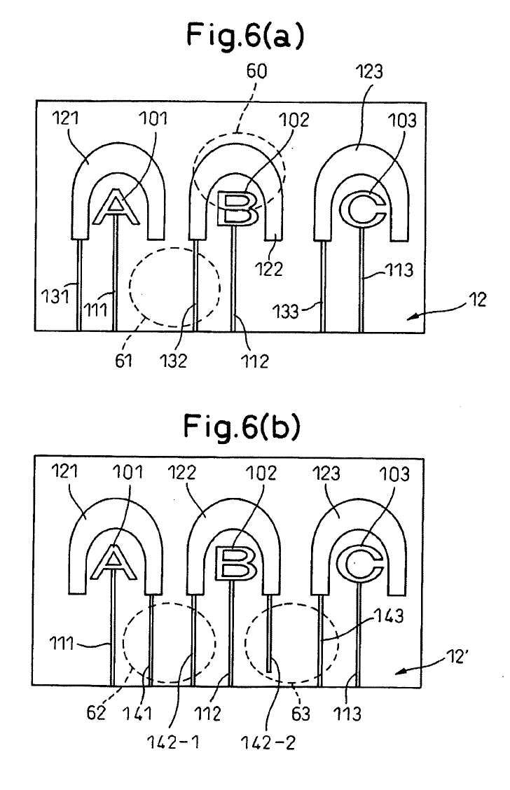

FIG. 6 is a diagram showing another example of the transparent electrode pattern.

FIG. 6(a) shows one example of the first transparent electrode pattern 12 which is the same as that shown in FIG. 2(a), and FIG. 6(b) shows one example of an alternative first transparent electrode pattern 12′. The alternative first transparent electrode pattern 12′ shown in FIG. 6(b) can be used instead of the first transparent electrode pattern 12 of the liquid crystal device 10. In FIGS. 6(a) and 6(b), the same elements as those in FIG. 2 are designated by the same reference numerals.

In FIG. 6(a), when the user touches the portion shown by a dashed circuit 60, the user input position can be determined using the second sensor electrode 122 by the detection circuit such as shown in FIG. 4. However, when the user touches the portion shown by a dashed circuit 61, a capacitance occurs between the wiring line 132 and the finger, giving rise to the possibility of the detection circuit erroneously detecting that the user has touched the portion corresponding to the second sensor electrode 122.

To address this, in the example of the alternative first transparent electrode pattern 12′ shown in FIG. 6(b), a wiring line to each sensor electrode is formed in close proximity to a wiring line to its adjacent sensor electrode (for example, close enough that when a portion near one wiring line is touched with a normal size finger, the finger invariably touches the two adjacent wiring lines simultaneously). In other words, the wiring line 141 to the first sensor electrode 121 is formed in close proximity to the first wiring line 142-1 to the second sensor electrode 122, while the wiring line 143 to the third sensor electrode 123 is formed in close proximity to the second wiring line 142-2 to the second sensor electrode 122. Accordingly, if the portion shown by a dashed circuit 62 or 63 is inadvertently touched with a finger, the finger invariably touches the two adjacent wiring lines simultaneously. Since only one wiring line is needed for the second sensor electrode 122, the second wiring line 142-2 may be called a dummy wiring line (for erroneous detection prevention).

When the wiring lines to the sensor electrodes are arranged as described above, the controller 27 performs control so that if it is determined by the detection circuit that an input position is detected at more than one sensor electrode, the detection of such an input position is canceled by interpreting it as being an erroneous input. By performing control in this way, an erroneous input such as shown by the dashed circuit 61 in FIG. 6(a) can be excluded.

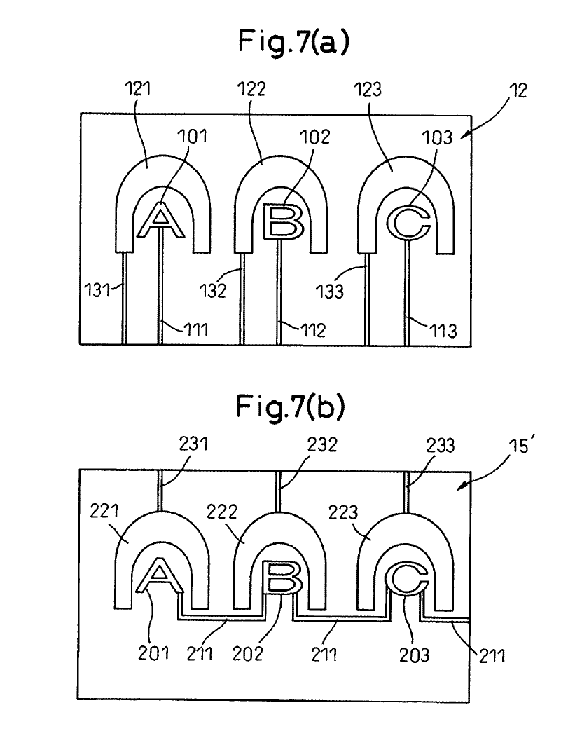

FIG. 7 is a diagram showing still another example of the transparent electrode pattern. This example is effective as the thickness of the liquid crystal layer changes with pressing force.

FIG. 7(a) shows one example of the first transparent electrode pattern 12 which is the same as that shown in FIG. 2(a), and FIG. 7(b) shows one example of an alternative second transparent electrode pattern 15′. The alternative second transparent electrode pattern 15′ shown in FIG. 7(b) can be used instead of the second transparent electrode pattern 15 of the liquid crystal device 10. In FIGS. 7(a) and 7(b), the same elements as those in FIG. 2 are designated by the same reference numerals.

In FIG. 7(b), the transparent electrode pattern includes a first counter electrode 201 disposed opposite the first segment electrode 101, a second counter electrode 202 disposed opposite the second segment electrode 102, a third counter electrode 203 disposed opposite the third segment electrode 103, and wiring lines 211 interconnecting the counter electrodes. The first counter electrode 201, second counter electrode 202, third counter electrode 203, and wiring lines 211 are all held at the same potential and thus function as a common electrode.

The transparent electrode pattern further includes a first sensor counter electrode 221 disposed opposite the first sensor electrode 121, a second sensor counter electrode 222 disposed opposite the second sensor electrode 122, a third sensor counter electrode 223 disposed opposite the third sensor electrode 123, a wiring line 231 to the first sensor counter electrode 221, a wiring line 232 to the second sensor counter electrode 222, and a wiring line 233 to the third sensor counter electrode 223.

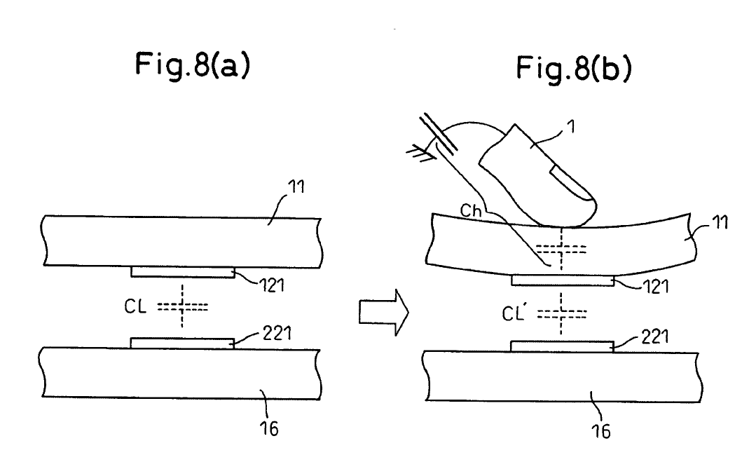

FIG. 8 is a diagram showing a capacitance that occurs between the finger and the sensor electrode shown in FIG. 7.

FIG. 8(a) shows the case where the finger is not placed on the sensor electrode, and FIG. 8(b) shows the case where the finger is placed on the sensor electrode.

As shown in FIG. 8(a), when the user's finger 1 is not placed on the first transparent substrate 11 at a position corresponding, for example, to the first sensor electrode 121, the capacitance Ch which is the sum of the series capacitance between the first sensor electrode 121 and the human body via the finger does not occur. On the other hand, when the user's finger 1 is placed on the first sensor electrode 121, as shown in FIG. 8(b), the capacitance Ch occurs between the first sensor electrode 121 and the finger, as in the case shown in FIG. 3.

When the alternative second transparent electrode pattern 15′ shown in FIG. 7(b) is used, a capacitance CL is present between the first sensor electrode 121 and the first sensor counter electrode 221. When the finger is placed on the sensor electrode, as shown in FIG. 8(b), since the first transparent substrate 11 is formed from a thin plastic material, the distance between the first and second transparent substrates 11 and 16 becomes slightly shorter. As a result, the capacitance between the first sensor electrode 121 and the first sensor counter electrode 221 changes to CL′. Since the capacitance is inversely proportional to the distance between the electrodes, CL′>CL.

When using the capacitance formed between the first sensor electrode 121 and the first sensor counter electrode 221, as shown in FIG. 8(b), either the first transparent substrate 11 or the second transparent substrate 16 or both must have flexibility. The first and second transparent substrates 11 and 16 may be formed from a thin glass material, but a plastic material is preferred because it has greater flexibility.

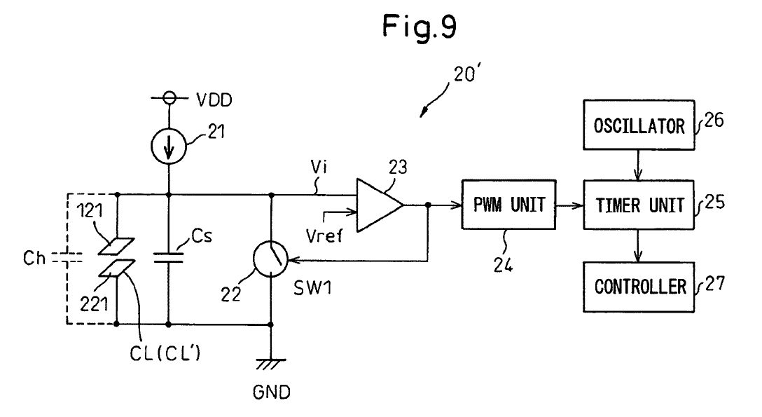

FIG. 9 is a schematic diagram showing the configuration of the detection circuit corresponding to FIGS. 7 and 8.

In FIG. 9, the same elements as those in FIG. 4 are designated by the same reference numerals. The detection circuit 20′ shown in FIG. 9 differs from the detection circuit 20 shown in FIG. 4 only in that when a finger is placed on the sensor electrode, the total capacitance that the constant current source 21 charges is Cs+CL′+Ch and, when a finger is not placed on the sensor electrode, the total capacitance that the constant current source 21 charges is Cs+CL.

In the detection circuit 20 shown in FIG. 4, when a finger is placed on the sensor electrode, the total capacitance that the constant current source 21 charges is Cs+Ch and, when a finger is not placed on the sensor electrode, the total capacitance that the constant current source 21 charges is Cs, the difference being only Ch (about 10 pF). On the other hand, in the detection circuit 20′ shown in FIG. 9, the difference between the case where a finger is placed on the sensor electrode and the case where a finger is not present is Ch+(CL′−CL), and this increased difference serves to further facilitate the detection.

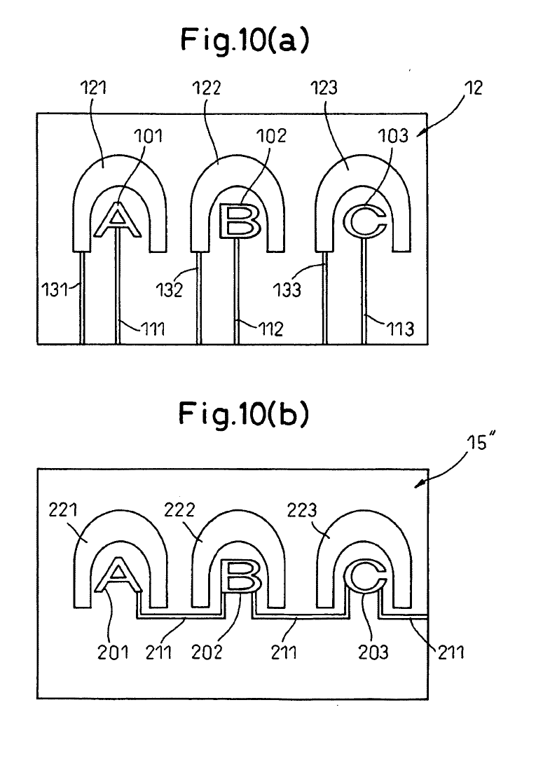

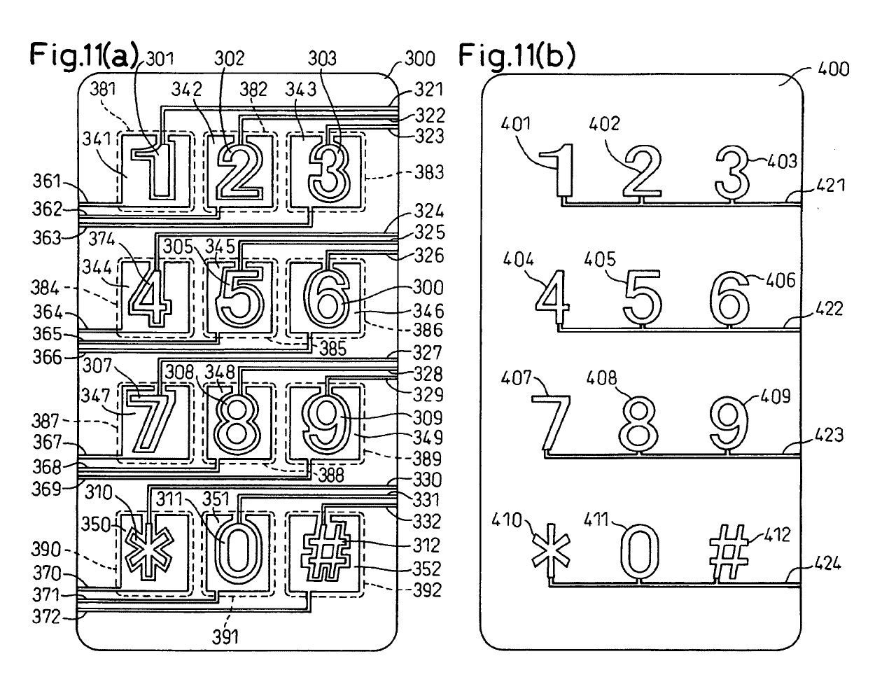

FIG. 10 is a diagram showing a further example of the transparent electrode pattern.

FIG. 10(a) shows one example of the first transparent electrode pattern 12 which is the same as that shown in FIGS. 2(a) and 7(a), and FIG. 10(b) shows one example of an alternative second transparent electrode pattern 15″. The alternative second transparent electrode pattern 15″ shown in FIG. 10(b) can be used instead of the second transparent electrode pattern 15 of the liquid crystal device 10. In FIGS. 10(a) and 10(b), the same elements as those in FIG. 7 are designated by the same reference numerals.

The difference between FIG. 10(b) and FIG. 7(b) is that, in FIG. 10(b), the wiring line 231 to the first sensor counter electrode 221, the wiring line 232 to the second sensor counter electrode 222, and the wiring line 233 to the third sensor counter electrode 223 are eliminated, thus placing the first sensor counter electrode 221, the second sensor counter electrode 222, and the third sensor counter electrode 223 in a floating potential state.

In FIG. 10(b), the counter electrodes 221, 222, and 223 are used to adjust the appearance. For example, when light transmitted through the second transparent substrate 16 propagates toward the first transparent substrate 11, the light passes through the transparent electrode layer 15, the liquid crystal layer 17, and the transparent electrode layer 12 in the sensor section and well as in the segment section. On the other hand, in the example of FIG. 2, since there is no transparent electrode layer 15 in the sensor section, the appearance differs between the segment section and the sensor section. When the counter electrodes 221, 222, and 223 are disposed on the viewer side, the appearance further improves.

Further, in FIG. 10(b), since the counter electrodes 221, 222, and 223 are floated, the amount of change of CL decreases compared with the structure of FIG. 7, but the elimination of the wiring lines serves to enhance design freedom. Further, compared with the structure of FIG. 2, the amount of change of CL contributes to the detection sensitivity.

FIG. 11 is a diagram showing a still further example of the transparent electrode pattern.

FIGS. 11(a) and 11(b) show examples of a first transparent electrode pattern 300 and a second transparent electrode pattern 400, respectively, while the electrode patterns are essentially the same in structure as those shown in FIGS. 2(a) and 2(b), the segment electrodes shown here are specifically designed for input keys of mobile phones.

In the example of FIG. 11(a), the first transparent electrode pattern 300 includes segment electrodes 301 to 312 having the shapes of numbers “1” to “0”, “*”, and “#”, wiring lines 321 to 332 to the respective segment electrodes 301 to 312, sensor electrodes 341 to 352, and wiring lines 361 to 372 to the respective sensor electrodes.

The sensor electrodes 341 to 352 are arranged in close proximity to the respective segment electrodes 301 to 312 so as to surround the respective segment electrodes, and are formed within respective touch areas 381 to 392 each designed to be pressed with the user's finger 1. Further, like the sensor electrodes 121 to 123 shown in FIG. 2(a), each of the sensor electrodes 341 to 352 has a larger area than the corresponding segment electrode.

In the example of FIG. 11(b), the second transparent electrode pattern 400 includes counter electrodes 401 to 412 disposed opposite the respective segment electrodes 301 to 312 and wiring lines 421 to 424 to the respective counter electrodes 401 to 412. The counter electrodes 401 to 412 and the wiring lines 421 to 424 are all held at the same potential and thus function as a common electrode. The counter electrode wiring lines 421 to 432 are formed so as not to overlap with the segment wiring lines 321 to 332.

In the liquid crystal display 10, the first transparent electrode pattern 300 shown in FIG. 11(a) can be used instead of the first transparent electrode pattern 12 shown in FIG. 2(a), and the second transparent electrode pattern 400 shown in FIG. 11(b) can be used instead of the second transparent electrode pattern 15 shown in FIG. 2(b). Further, since the example shown in FIG. 11 differs from the example shown in FIG. 2 only in the shape and number of segment electrodes and sensor electrodes, the position of the segment pressed by the finger can be determined using the same detection circuit and detection method shown in FIGS. 3 to 5, and the same function can thus be accomplished.

What is claimed is:

1. A liquid crystal device comprising:
a liquid crystal layer provided between first and second substrates; and
a capacitive sensor electrode, which is not provided with a counter electrode, and a segment electrode for driving a liquid crystal, both formed on said first or second substrate at a side thereof that faces said liquid crystal layer.

2. The liquid crystal device according to claim 1, wherein said capacitive sensor electrode is disposed around said segment electrode.

3. The liquid crystal device according to claim 1, wherein said counter electrode is held in a floating state.

4. The liquid crystal device according to claim 1, wherein said capacitive sensor electrode and said segment electrode are formed on said first substrate or said second substrate, whichever is located on a viewer side.

5. The liquid crystal device according to claim 1, wherein said segment electrode and said capacitive sensor electrode are formed in a touch area within said liquid crystal device.

6. The liquid crystal device according to claim 1, wherein said capacitive sensor electrode is formed larger in area than said segment electrode.

7. The liquid crystal device according to claim 1, further comprising an erroneous detection prevention wiring line connected to said capacitive sensor electrode.

8. The liquid crystal device according to claim 1, further comprising a plurality of capacitive sensor electrodes and a plurality of wiring lines connected to said plurality of capacitive sensor electrodes, and wherein said plurality of wring lines are arranged one adjacent to another.

9. The liquid crystal device according to claim 1, wherein said segment electrode is an electrode for passive driving.

10. The liquid crystal device according to claim 1, wherein said first or second substrate is a flexible substrate.

11. The liquid crystal device according to claim 1, wherein a voltage for said capacitive sensor electrode is set smaller than a voltage applied to said liquid crystal layer.
